(19) United States
(12) Patent Application Publication
(10) Pub. No.: US 2008/0224835 A1
(43) Pub. Date: Sep. 18, 2008

(54) Tamper resistant switch combination device

(75) Inventor: Marc Noest, Westbury, NY (US)

Correspondence Address: Collard & Roe, P.C./Leviton, 1077 Northern Blvd, Roslyn, NY, 11576, US

(73) Assignee: Leviton Manufacturing Company, Inc.

(21) Appl. No.: 11/724,751

(22) Filed: Mar. 16, 2007

(51) Int. Cl. G08B 5/36

(52) U.S. Cl. 340/286.11

(57) ABSTRACT

The disclosure relates to an electrical device comprising a housing, a tamper resistant switch disposed in the housing, and an electrical component disposed in the housing. In this case, the tamper resistant switch can be in electrical communication with the electrical component to selectively electrically connect the electrical component with at least one electrical contact such as a power input. The electrical component can be in the form of a receptacle outlet, a motion sensor, an indicator light or additional tamper resistant switches. In one embodiment, the electrical component can be coupled in series with the tamper resistant switch to be selectively turned on. For example there can be a tamper resistant switch disposed in a housing along with a motion sensor or light sensor. In the case of a motion sensor, the tamper resistant switch can be turned to an on position to activate the motion sensor. If the motion sensor detects motion, then this motion sensor can be used to activate a load such as a light electrically coupled to the device.

### BACKGROUND OF THE INVENTION

The invention relates to a combination tamper resistant switch and an additional component such as an outlet, a sensor, or other type electrical component disposed in a single gang electrical enclosure.

Tamper resistant switches are known in the art. For example, U.S. Pat. No. 3,497,646 to Poliak issued on Feb. 24, 1970 relates to a tamper proof key-operated electric switch wherein the disclosure of this patent is hereby incorporated herein by reference in its entirety. Tamper proof switches are designed to be operated by a specially designed key and are constructed to prevent unauthorized operation by devices such as nails, wires, screw drivers, knives or other related implements.

In addition, a single gang receptacle outlet and switch combination have been shown in U.S. Pat. No. 2,752,581 Benander issued on Jun. 26, 1956.

One feature not addressed by the above references is a tamper resistant switch incorporated into a single gang electrical enclosure having at least one additional electrical component incorporated therein.

### SUMMARY OF THE INVENTION

One embodiment of the invention relates to a tamper resistant switch disposed in a single gang electrical enclosure with an additional electrical component disposed therein. In this case, there can be two electrical contacts or terminals inside the housing wherein the tamper resistant switch controls the distribution of power to at least one of the two contacts. One or both of the contacts or terminals can be associated with the additional component inside of the housing. Another contact can be coupled to contacts for a downstream load such as a light disposed outside of the housing.

For example, in one embodiment, there can be a tamper resistant switch which is disposed in a single gang electrical housing with a user accessible interface such as a receptacle. In one embodiment, the tamper resistant switch could be wired to control a downstream load not associated with the receptacle. In another embodiment, the tamper resistant switch could be wired in series with the receptacle to control power to that receptacle. In still another embodiment the tamper resistant switch could be wired to control power to both the first set of contacts such as a receptacle interface and an additional set of contacts associated with another load such as a light disposed outside of the housing. Thus, with this embodiment, the tamper resistant switch controls both loads.

The tamper resistant switch disposed inside of the single gang electrical enclosure can be associated with many different types of electrical components. For example, these components can include an electrical outlet as recited above, a ground fault circuit interrupter (GFCI) based outlet, a motion sensor, a light sensor, an indicator light, an additional tamper resistant switch, or any other possible additional component that can be adapted to fit inside of this housing.

Thus, in at least one embodiment, there can be two or more switches disposed in one housing. These switches can be coupled in parallel, such that each switch controls a different downstream load separately. Alternatively, the two or more switches can be electrically coupled in series with each other such that a first switch controls a second switch disposed inside the housing. For example, in one embodiment, the tamper resistant switch could be wired to control a motion or occupancy sensor. The motion or occupancy sensor acts as a switch as well. In this case, when a user turns the tamper resistant switch to an “on” position, the motion sensor is then activated. Once the motion sensor is activated, it actively determines whether there is sufficient motion based upon a predetermined value. If the sensor determines a sufficient amount of motion, it can then activate a downstream load not disposed in the housing such as a light. Alternatively, the additional switch can be in the form of a light sensor having a switch associated with it as well. This light sensor, when activated by the tamper resistant switch, would then turn on a light disposed outside of the housing in response to a detection of a predetermined level of low light or darkness. Conversely, the light sensor could be configured to respond to a predetermined level of brightness.

In at least one embodiment, there can be at least three switches disposed in a single gang electrical enclosure. For example, there could be two tamper resistant switches, with at least one tamper resistant switch coupled in series with, or controlling either a light sensor or an occupancy/motion sensor forming the third switch. In another embodiment the third switch could be coupled in parallel with the first two switches.

The tamper resistant switches can be formed as a single pole switch. Alternatively, the tamper resistant switches can be formed as a multi-pole or a multi-position switch. In this case, these multi-pole or multi-position switches can be substituted for a single pole switch. For example, with this type of embodiment, the switch is disposed in a single gang electrical enclosure along with the additional electrical component wherein one of the poles or one of the positions of this multi-position or multi-pole switch can be coupled in series with, and used to control the additional electrical component. In addition, one of the other poles or positions can also be coupled in series with the electrical component. Alternatively, both positions or poles of the switch could be coupled to a series of contacts associated with a downstream load not associated with the additional electrical component.

Thus, one embodiment of the tamper resistant switch can be in the form of a double pole switch for controlling both sides of a circuit, such as for example, the phase and neutral lines of a single phase circuit, or to control two different phases in a multi-phase connection.

Another embodiment of the tamper resistant switch can be in the form of a three-way switch for controlling a load from two different locations with two different switches. In still another embodiment of the invention, the tamper resistant switch can be in the form of a four-way switch which is used to control the load from more than two locations.

Another embodiment of the tamper resistant switch can be in the form of a momentary contact single pole, double throw center off-switch. In this case, the center position relates to the “off” condition, while the two opposite end positions are for actuating either different devices or for operating a motor in a particular direction. With this design, the switch is biased in the off position but it can be held in one of the actuating positions by a user.

In still another embodiment, the tamper resistant switch is in the form of a momentary contact double pole throw center off-switch. This switch is the same as above, but it can be used for a double phase network, for example industrial applications.

In another embodiment, the tamper resistant switch is in the form of a maintained contact single pole double throw center off switch. With a maintained contact switch, the switch is not biased in the off position. Instead, a user can turn this switch to a particular position at either pole and then leave this switch in that position.

In another embodiment, the tamper resistant switch is in the form of a maintained contact double pole double throw center off switch which is similar to the device above, but this switch is used in a two or more phase network which may be suitable for industrial applications.

By incorporating the tamper resistant switch with another electrical component into a single gang electrical enclosure, the device can function as a compact, multi-function single enclosure device that can be incorporated into a single gang electrical enclosure without the need for additional unnecessary components. Thus, embodiments of the present invention can now be placed in publicly accessible hallways or rooms having single gang wall boxes. Without the design of these embodiments, multiple wall boxes, or multi-gang wall boxes would be required to achieve the same result. This could be problematic in an existing installation where a significant amount of work may be required to add additional boxes.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a perspective view of a key-switch combination device;

FIG. 2A is a top view of the embodiment shown in FIG. 1;

FIG. 2B is a side view of the embodiment shown in FIG. 1;

FIG. 3A is a top view of one embodiment showing contacts disposed on the housing;

FIG. 3B is a side cross-sectional view of the switch taken along the line III-III in FIG. 3A;

FIG. 4 is a back view of the embodiment shown in FIG. 1;

FIG. 5 is an end view of the embodiment shown in FIG. 1;

FIG. 6 is another embodiment of the invention showing a tamper resistant switch and an indicator light;

FIG. 7 is another embodiment of the invention showing a tamper resistant switch and a motion or light sensor;

FIG. 8A is a front view of another embodiment of the invention showing two tamper resistant switches;

FIG. 8B is a front view of another embodiment of the invention showing two tamper resistant switches with a motion or light sensor;

FIG. 8C is a front view of another embodiment including three tamper resistant switches disposed in the housing;

FIG. 8D is a front view of another embodiment showing the tamper resistant switch incorporated into a enclosure having a GFCI receptacle;

FIG. 9A is a schematic electrical diagram of one embodiment of the design shown in FIG. 1;

FIG. 9B is an alternative schematic electrical diagram of the design shown in FIG. 1;

FIG. 9C is an electrical diagram of the embodiment shown in FIG. 6;

FIG. 9D is a schematic electrical diagram of one embodiment of the design shown in FIG. 7 and 8A;

FIG. 9E is a schematic electrical diagram of one embodiment of the design shown in FIGS. 7 and 8A;

FIG. 9F is an alternative schematic electrical diagram of the design shown in FIG. 8B;

FIG. 9G is a schematic electrical diagram of the design shown in FIG. 8B;

FIG. 10A shows a standard connection for a double pole switch;

FIG. 10B shows a standard connection for a 3-way switch;

FIG. 10C shows a standard connection for a 4-way switch;

FIG. 10D shows a standard connection for a single pole, double throw center off switch; and

FIG. 10E shows a standard connection for a double pole throw center off switch.

### DETAILED DESCRIPTION OF PREFERRED EMBODIMENTS

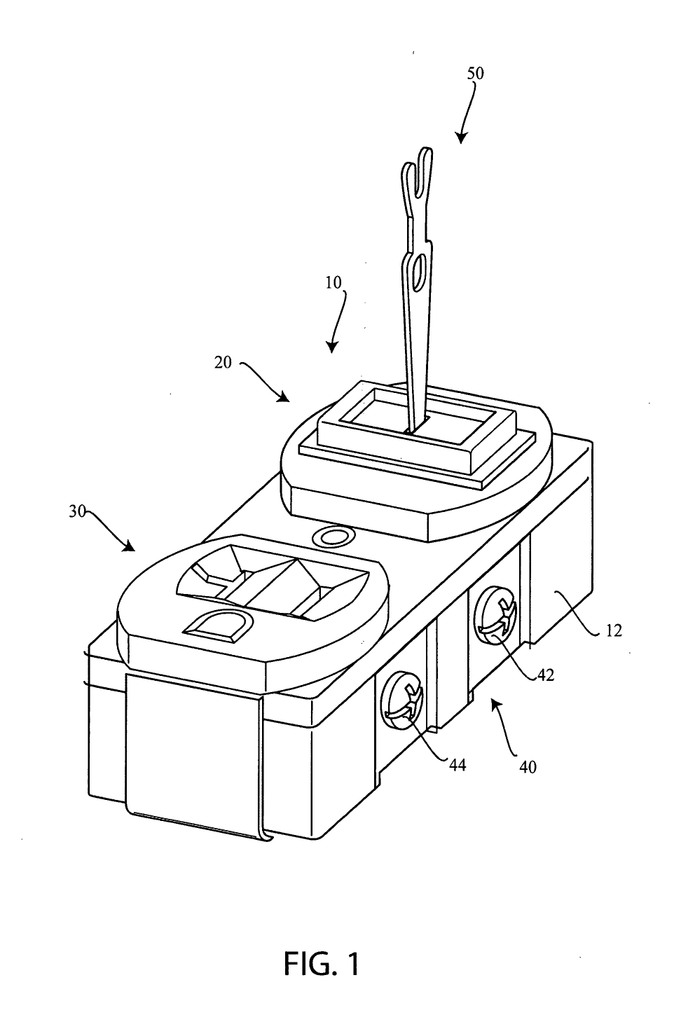

FIG. 1 is a perspective view of a first embodiment of a device 10 that includes a housing 12 in the form of a single gang electrical enclosure, a tamper resistant switch 20 and a receptacle interface 30. There is a key 50 that fits into tamper resistant switch 20 as well. This tamper resistant switch 20 can generally only be activated with the use of this key, thereby preventing unauthorized users from tampering with the switch. Switch 20 can be used to control power to receptacle interface 30 and/or be used to control power to components disposed outside of the housing as well. This housing includes a set of contacts 40 including contacts 42 and 44.

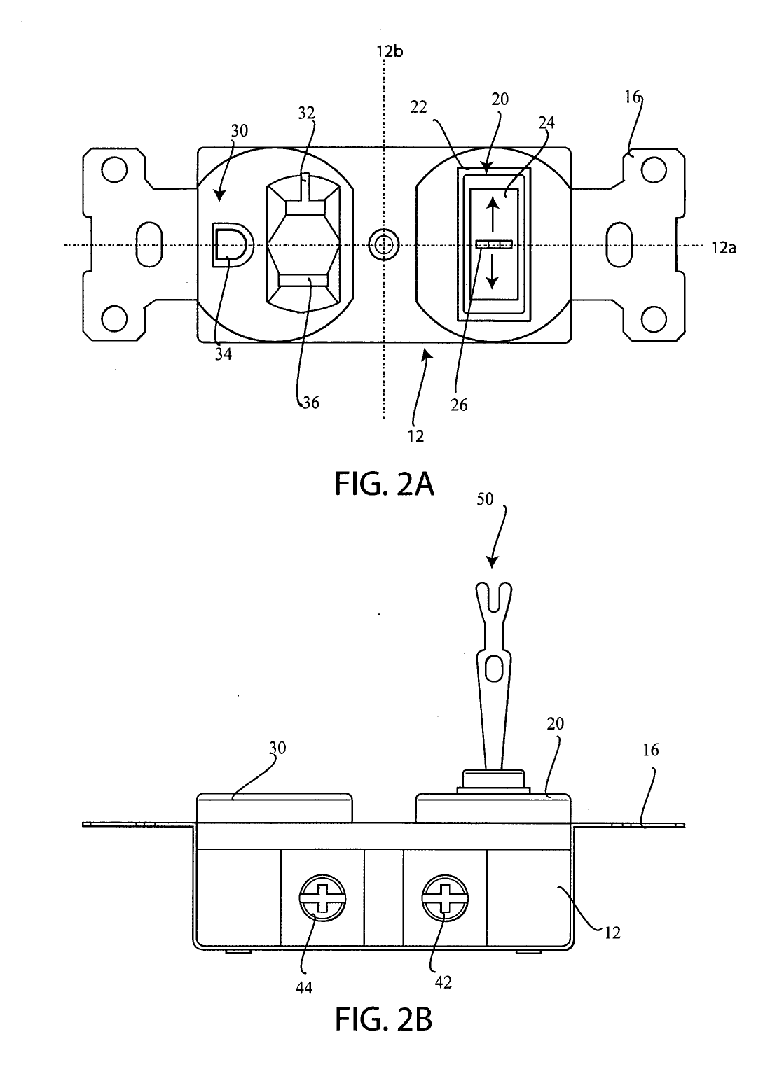

FIG. 2A discloses a top view of the device which shows housing 12 coupled to strap 16 and which includes tamper resistant switch 20 having a switch housing 22, a switch interface 24, and a key interface 26. In addition, this view shows receptacle interface 30 having prong openings 32, 34, and 36. These components are all disposed inside of, or coupled to housing 12. Housing 12 has a length defined by a longitudinal axis 12a and a width defined by a latitudinal axis 12b. While not required, the length of housing 12 can be longer than the width of this housing.

FIG. 2B discloses a side view of the device disposed in FIGS. 1 and 2A showing housing 12, contacts 42 and 44 and strap 16 along with switch 20, receptacle interface 30 and key 50.

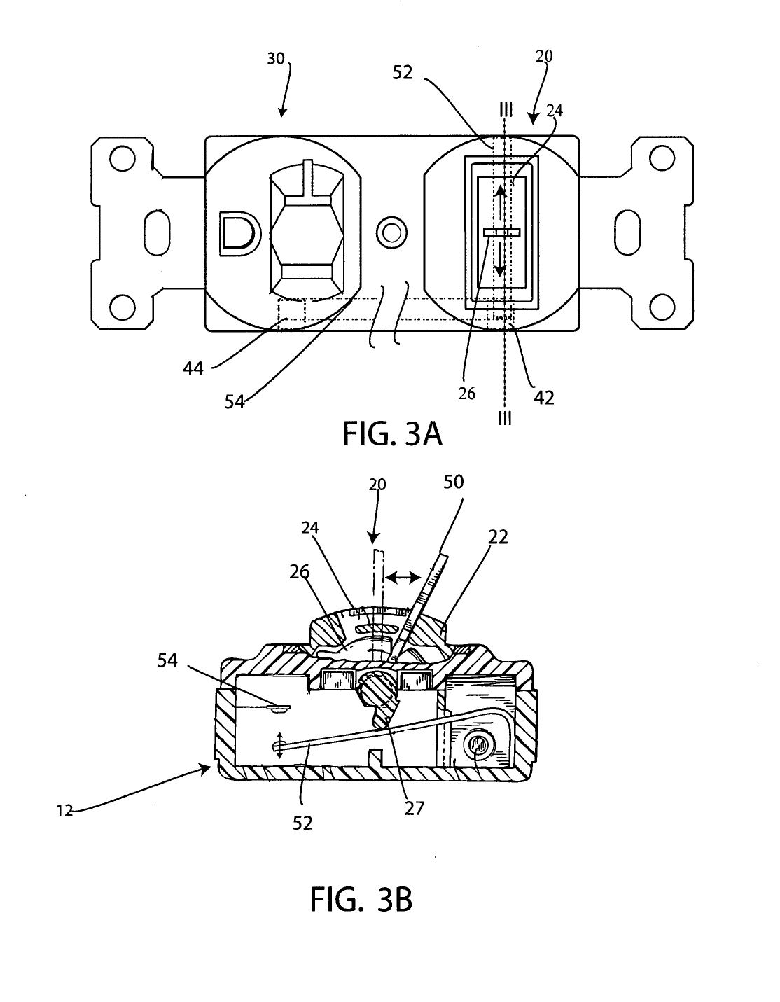

FIG. 3A is a top view of one embodiment showing contacts 52 and 54 disposed inside the housing. In this case, contact 52 extends along the width of the housing while contact 54 extends along the length of housing 12, adjacent to one side. Contact 52 extends adjacent to tamper resistant switch 20 and underneath switch interface 24 and key interface 26.

FIG. 3B is a side cross-sectional view of one example of a tamper resistant switch 20 taken along the line III-III in FIG. 3A. Switch 20 has a switch housing 22, a switch interface 24, and a key interface 26. Key interface 26 is designed to receive key 50. Switch 20 also includes a cam 27 which is operated by the movement of key 50 once it is inserted into interface 26. There are at least two contacts including a power input contact or terminal 52 and a power receiving contact or terminal 54 for receiving power from power input contact 52 when key 50 is rotated into an “on” position. Power input contact 52 is adapted to be coupled to any one of the contacts 40 (See FIG. 1) to receive power from a power input line. It should be noted that contact 54 could be the input power contact and contact 52 could be the power receiving contact without departing from the spirit of this invention.

Contact 52 is a leaf spring and is biased in a position that is in contact with contact 54. When contact 52 is in contact with contact 54, the switch is in the closed, or “on” position allowing power to flow from contact 52 to contact 54. When contact 52 is moved to a position away from contact 54 via cam 27, then the switch is in the open or “off” position preventing power from flowing from contact 52.

To fit these components inside of housing 12, tamper resistant switch 20 is positioned such that when a key 50 is inserted, it can be used to rotate switch 20 such that cam 27, of switch 20, has a rotational axis extending substantially parallel to the longitudinal axis 12a of housing 12. Essentially, key 50 can be pushed back and forth in the direction of the width 12b of housing 12 to selectively turn on or off the switch.

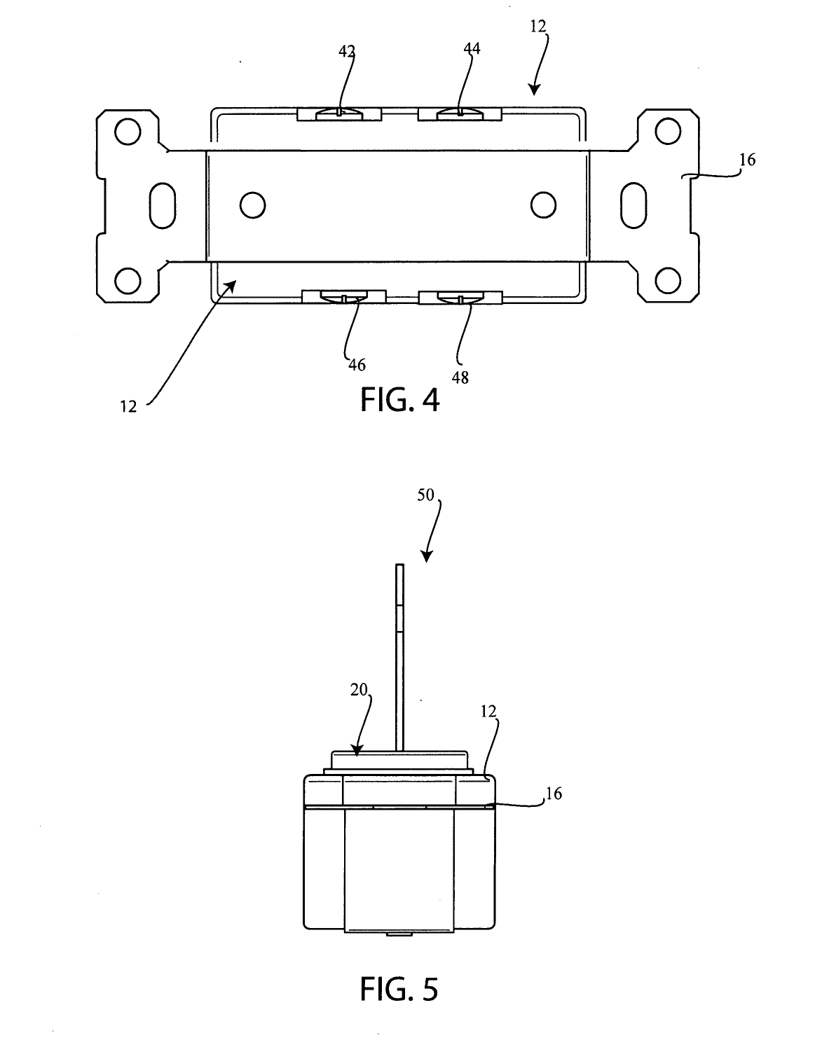

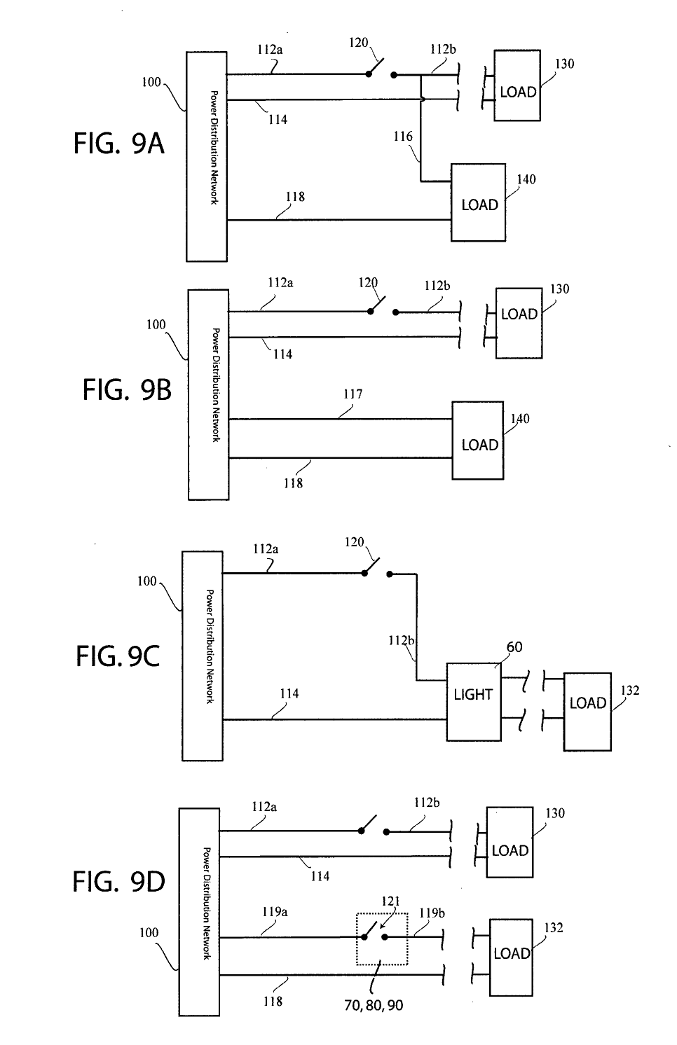

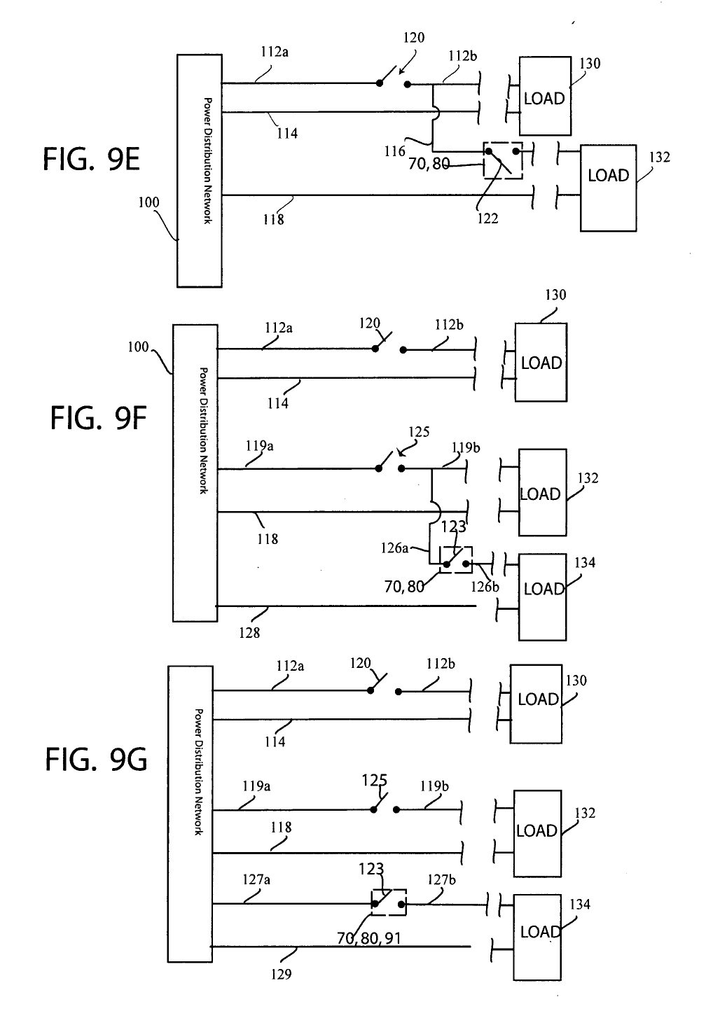

FIG. 4 shows a back view of housing 12, showing contacts 42, 44, 46, 48, and strap 16 while FIG. 5 shows an end view of this device. The electrical diagram for this device having a single pole tamper resistant switch 20 is shown in FIGS. 9A and 9B.

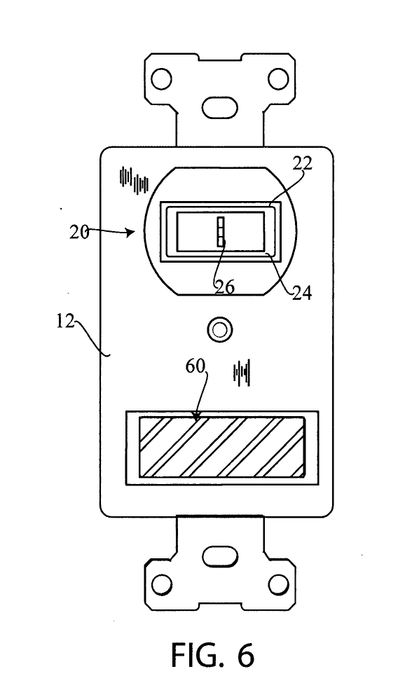

FIG. 6 shows a front view of another embodiment of the device. For example, there is shown a tamper resistant switch 20 which is disposed in housing 12. Tamper resistant switch 20 includes a switch housing 22, a switch interface 24 and a key interface 26. An indicator light 60 is disposed in housing 12. This indicator light is used to indicate the activation of a downstream load that could be coupled to any one of contacts 42, 44, 46 or 48 (See FIG. 4) in the housing. In this case, FIG. 9C shows the electrical connection diagram of this device. The indicator light can be configured to be illuminated when the downstream load is energized. Alternatively, the indicator light can be configured to be illuminated when the downstream device is not energized.

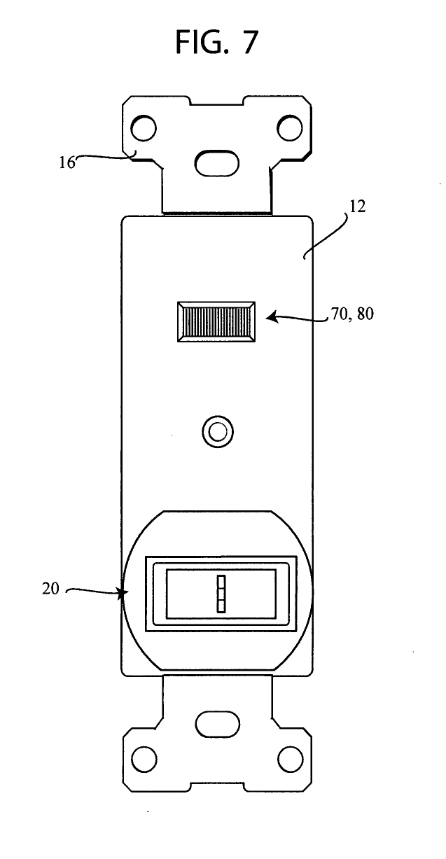

FIG. 7 is a front view of another embodiment of the invention. In this case, there is shown a body section or housing 12 which can be used to house both a tamper resistant switch 20 and a motion sensor 70. Motion sensor 70 can optionally be in electrical connection with tamper resistant switch 20, wherein if tamper resistant switch 20 is activated, causing an associated switch to be closed, then sensor 70 can also be activated. Alternatively, instead of a motion sensor 70, a light detecting sensor 80 can be used instead. In this case, the associated alternative electrical diagrams for these embodiments are shown in FIGS. 9D and 9E.

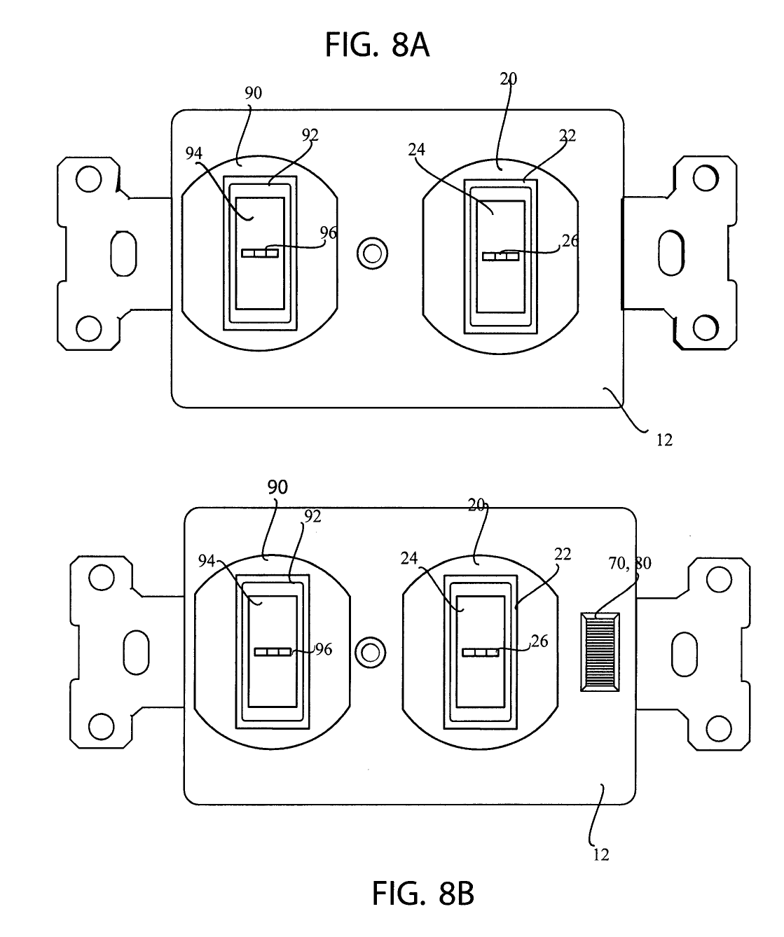

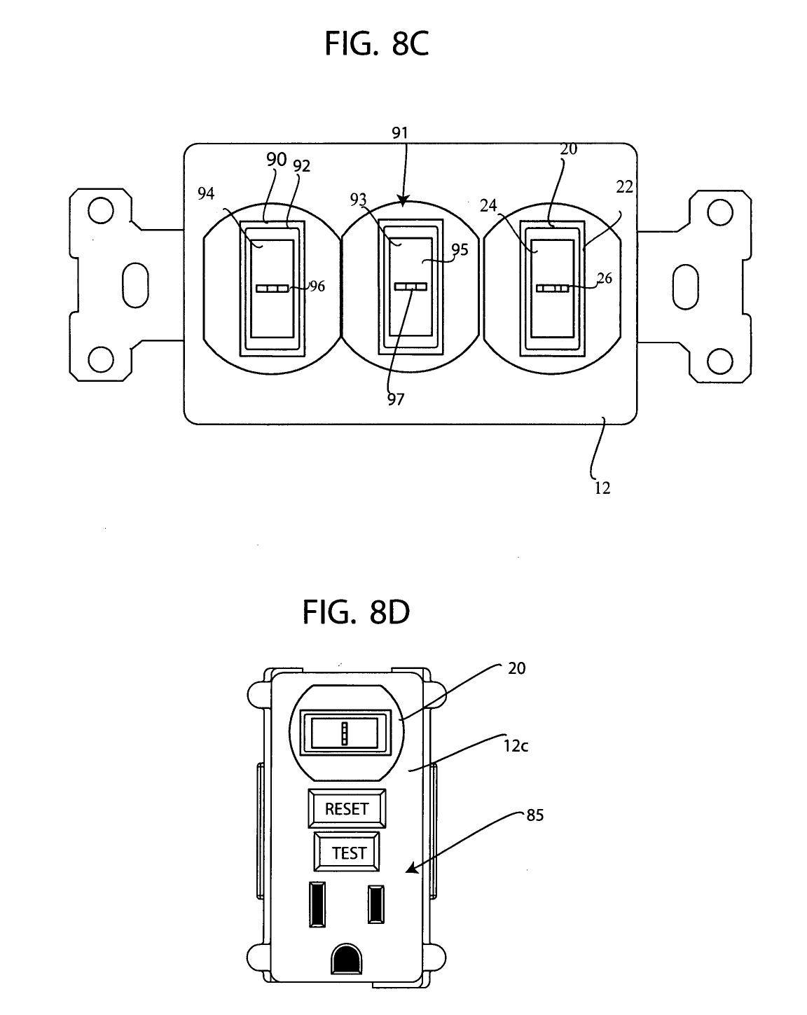

FIG. 8A is a front view of another embodiment of the device. In this case, there are two tamper resistant switches 20 and 90 disposed in housing 12. First tamper resistant switch 20 includes a switch housing 22, a switch interface 24, and a key interface 26. Second switch 90 includes a second switch housing 92, a switch interface 94, and a key interface 96. The electrical diagram for this device is shown in FIG. 9D.

FIG. 8B shows a front view of the device which is similar to the device shown in FIG. 8A, however, this device also includes a motion or occupancy sensor 70 disposed inside of housing 12. In this case, motion sensor 70 can optionally be coupled in series with a first tamper resistant switch 20 wherein the associated electrical diagram is shown in FIG. 9F. Alternatively, the motion sensor 70 can be coupled in separately from tamper resistant switch 20 wherein this is shown in FIG. 9G. In addition, as above, instead of using a motion sensor 70, a light detecting sensor 80 can be used as well. FIGS. 9F and 9G show the associated electrical diagrams for this device.

FIG. 8C is a front view of another embodiment including three tamper resistant switches disposed in the housing. In this view, there is an additional switch 91 which has a switch housing 93, a switch interface 95, and a switch or key interface 97. Each of these switches 20, 90 and 91 can be used to control separate downstream loads, wherein the electrical diagram of this device is shown in FIG. 9G.

FIG. 8D shows an embodiment showing tamper resistant switch 20 incorporated into a single gang electrical enclosure or housing 12c having a GFCI component 85 disposed therein which includes a receptacle and test and reset buttons. With this design, additional components can be added into housing 12c such as an indicator light 60, motion sensor 70, a light detector 80, or an additional switch 90 as well.

FIGS. 9A and 9B show the two electrical diagrams for the embodiment shown in FIGS. 1-5. For example, there is a power distribution source or network 100 which is connected to contacts 40 (See FIG. 1) and can provide power to a power input line 112 and receive a return signal on line 114. These lines can extend inside of housing 12. Disposed on line 112 is a switch 120 which is associated with tamper resistant switch 20, wherein line 112 consists of power input line 112a disposed upstream from switch 120 and power input line 1 12b disposed downstream from switch 120. This line is then coupled to a downstream load 130. Downstream load 130 can be electronically coupled to contacts 40 on housing 12. In addition, there is an input line 116 which is coupled to line 112b which receives power from line 112b when switch 120 is closed.

Switch component 120 is activated by the mechanical movement of tamper resistant switch 20 which is shown in FIG. 1. In this case, tamper resistant switch 20 is activated only when key 50 is inserted therein. Once key 50 is turned, switch 120 can be either opened or closed to create either an open or closed circuit. When switch 120 is in a closed position, power is fed to an interface or load 140 which can be in the form of a receptacle 30.

In an alternative embodiment, as shown in FIG. 9B, switch 120 is only used to control power to downstream load 130 disposed outside of the housing, while load or interface 140 is coupled directly to lines 117 and 118.

FIG. 9C shows the electrical diagram for the device shown in FIG. 6. In this case, there is shown switch 120 that is associated with tamper resistant switch 20. Switch 120, when switched to a closed position, allows power to flow into line 112b, and then next flows into indicator light 60 and then onto a downstream load 130. With this type of design, a user would have the benefit of having an instant indication of whether there is a device disposed outside of the housing that is switched on. Conversely, the indicator light can be configured to be illuminated when power to a downstream load is “off.”

FIG. 9D discloses an electrical diagram for the embodiment disclosed in FIGS. 7 and 8A. For example, FIG. 7 discloses a tamper resistant switch 20 and a motion sensor or occupancy sensor switch 70 or a light sensor switch 80. Motion sensor switch 70 or light sensor switch 80, is shown schematically as including switch 121. Switch 121 receives power from power input line 119a wherein power continues on to line 119b and onto a downstream load 132 when switch 121 is in a closed position. With a motion sensor such as the motion sensor 70, motion causes a switch such as switch 121 to close, thus delivering power to downstream line 119b and load 132. Alternatively, if light sensor 80 is incorporated therein, then light detected by light sensor 80 then causes switch 121 to close causing power to flow to the downstream load. In this case, both downstream loads 130 and 132 can be electronically connected to the components inside housing 12 via contacts 40 or any other known contacts.

FIG. 9D also shows an electrical diagram for the embodiment shown in FIG. 8A. In this view, there are shown two tamper resistant switches 20 and 90 disposed in a single housing 12. Tamper resistant switch 20 is shown as a switch 120 in FIG. 9D while tamper resistant switch 90 is shown as switch 121.

Alternatively, FIG. 9E is another electrical circuit diagram for the embodiment shown in FIG. 7. For example, in this embodiment, motion sensor 70 or alternatively light sensor 80, are shown electrically by switch 122. In this embodiment, motion sensor 70, or light sensor 80 only operate when switch 120 is in a closed position thereby activating this motion sensor to close switch 122 when it detects a nearby motion or close switch 122 when light sensor 80 detects a predetermined level of low light or darkness. Downstream load 132 then receives power depending on whether both switches are closed. Downstream load 132 is an optional downstream load which can also be coupled to the electronic components in housing 12.

FIGS. 9F and 9G show the two different embodiments for the drawings shown in FIG. 8B and in FIG. 8C.

With this design, as shown in FIG. 9F, first tamper resistant switch 20 is associated with switch 120. Second tamper resistant switch 90 is associated with switch 125, while motion sensor 70, or light sensor 80 is shown as being coupled in series with a second tamper resistant switch which is shown as switch 125 via line 126a. Thus, when switch 125 is closed, power flows into line 126a, which energizes motion sensor 70, or light detection sensor 80. When motion sensor 70 detects the presence of movement, it closes switch 123 allowing power to flow through line 126b to load 134. Alternatively, in the embodiment using a light detection sensor 80, if switch 125 is turned to a closed position, light detector 80 is powered on and is then used to detect a relative presence or absence of light. At this predetermined condition, it closes the associated switch 123 allowing power to flow to load 134.

FIG. 9G discloses an alternative wiring design wherein tamper resistant switches 20 and 90 are shown schematically by switches 120 and 125, while motion sensor 70, or light sensor 80 or additional switch 91 is shown as switch 123. When switch 123 is closed, power can then flow from power input line 127a through switch 123, onto line 127b and then onto load 134.

With this tamper resistant switch coupled to another electrical device such as a receptacle, an indicator light or motion sensor, in a single gang electrical enclosure, there can be secure control of these electronic components in a single wall mounted unit.

With any of the above embodiments, any suitable tamper resistant switch can be used. For example, switch component 120 is shown in the preceding FIGS. 9A-9G as a single pole locking switch and can be in the form of a switch selected from Leviton® switch model no. 1101-21 or 1201-21 for 15 amp applications; model no. 1121-21 or 1221-21 for 20 amp applications; and model no. 3031-21 for 30 amp applications.

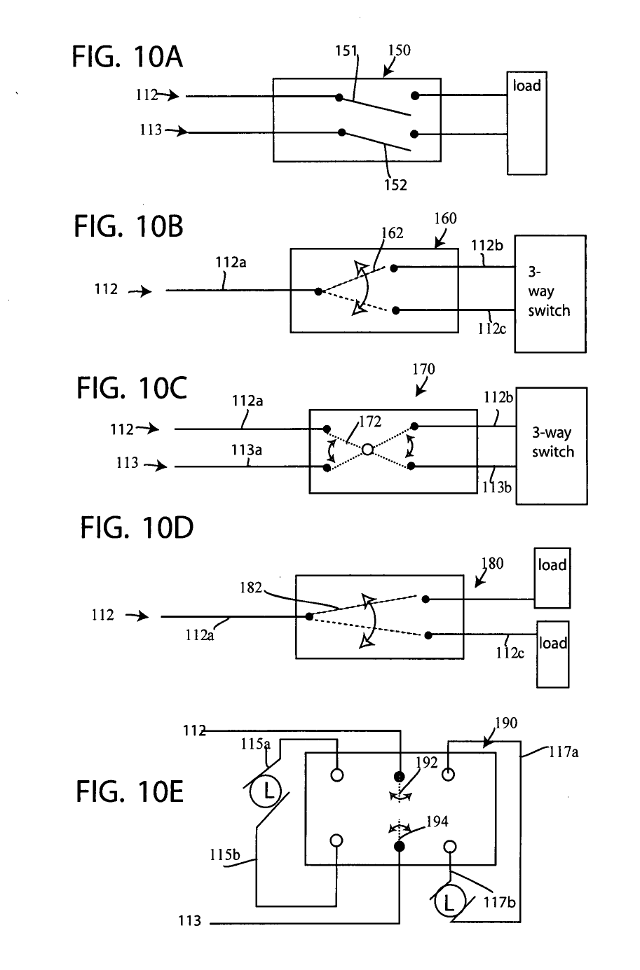

Alternatively, in another embodiment, tamper resistant switch 20 can include a switch component that can be in the form of a double pole locking switch 150 having two switches 151 and 152 and can be in the form of a Leviton® switch model no. 1102-21 or 1202-21 for 15 amp applications; model no. 1122-21 or 1222-21 for 20 amp applications; and model no. 3033-21 for 30 amp applications. An example of a double pole locking switch is shown in FIG. 10A. With this design, there are two power input lines 112 and 113 which can be coupled inside of housing 12.

In another embodiment, such as shown in FIG. 10B, switch 20 can be in the form of a 3-way switch 160 and can be in the form of a switch taken from Leviton® model no. 1203-21 for 15 amp applications; model no. 1223-21 for 20 amp applications; and model no. 3033-21 for 30 amp applications. In this case, the three-way switch 160 includes a single switch 162 which is coupled at one end to a pre-switch power input line 112a and which can be switched to one of two different post switch lines 112b or 112c to power another downstream three-way switch or a load.

In another embodiment, switch 20 can be in the form of a 4-way switch as shown by switch 170 in FIG. 10C. This switch can be in the form of a switch taken from Leviton® model no. 1104-21 or 1204-21 for 15 amp applications, and 1124-21 or 1224-21 for 20 amp applications. For example, switch 170 includes a switching element or contact 172 which can switch between any one of pre-switch power input lines 112a or 113a at a first end, and any one of post switch power input lines 112b or 113b at a second end, thereby selectively connecting any one of lines 112a or 113a with any one of lines 112b or 113b.

In another embodiment, switch 20 can be in the form of a momentary contact single pole double throw center off switch and can be in the form of a switch taken from Leviton® model no. 1256-L for 15 amp applications, and 1257-L for 20 amp applications. This type switch can be shown for example, in FIG. 10D as switch 180 having switching element or contact 182 connecting pre-switch line 112a with any one of lines 112b or 112c.

In still another embodiment switch 20 can be in the form of a maintained contact single pole double throw center off switch. This type device is also shown in FIG. 10D. In other embodiments, switch 20 can be in the form of a momentary contact, double pole throw center off switch, or in the form of a maintained contact double pole double throw center off switch. This type switch is shown by way of example in FIG. 10E as switch 190 having switching contacts or elements 192 and 194 which can move or rotate so that switch 192 can selectively contact lines 115a or 117a or switching element 194 can selectively contact lines 115b or 117b to power the associated loads marked “L”.

Thus, by incorporating a tamper resistant switch with another electrical component such as a receptacle, a pilot light, a motion sensor, or a light sensor, in a single gang electrical enclosure, this device can be placed in a compact location while having multiple uses.

Accordingly, while a few embodiments of the present invention have been shown and described, it is to be understood that many changes and modifications may be made thereunto without departing from the spirit and scope of the invention as defined in the appended claims.

What is claimed is:

1. A tamper resistant combination device comprising:
a) a housing in the form of a single gang electrical enclosure;
b) a tamper resistant switch connected to said housing and adapted to be coupled to at least one power input; and
c) a receptacle outlet having a user accessible interface connected to said housing;
wherein said tamper resistant switch is in electrical communication with said receptacle outlet to selectively electrically connect said receptacle outlet with the power input.

2. The device as in claim 1, wherein said tamper resistant switch comprises a switch, and a key interface for receiving a key.

3. The device as in claim 1, further comprising at least two power output connections, wherein a first power output connection is disposed in said receptacle outlet and an additional power output connection is coupled to said housing, wherein said tamper resistant switch is for selectively switching on or off power to said additional power output connection.

4. An electrical device comprising:
a) a housing in the form of a single gang electrical enclosure;
b) a first tamper resistant switch coupled to said housing, said first tamper resistant switch comprising an electrical switch and a key interface for receiving a key; and
c) at least one additional tamper resistant switch coupled to said housing, said at least one additional tamper resistant switch comprising an electrical switch and a key interface for receiving a key.

5. The device as in claim 4, further comprising at least one motion sensor, disposed in said housing.

6. The device as in claim 5, wherein said at least one motion sensor is coupled in series with at least one of said first or said at least one additional tamper resistant switch such that when said tamper resistant switch that is coupled to said motion sensor is switched on, said at least one motion sensor receives power.

7. The device as in claim 4, further comprising at least one light sensor disposed in said housing.

8. The device as in claim 7, wherein said at least one light sensor is coupled in series with at least one of said first or said at least one additional tamper resistant switch such that when said tamper resistant switch that is coupled to said light sensor is switched on, said at least one light sensor receives power.

9. The device as in claim 8, further comprising at least one power output connection which is connected in series with said light sensor, such that said light sensor is for selectively turning on or off power to said at least one power output, based upon a predetermined amount of light received by said light sensor.

10. A tamper resistant combination device comprising:
a) a housing in the form of a single gang electrical enclosure, said housing having a length and a width;
b) a tamper resistant switch connected to said housing and comprising a switch interface for receiving a key, wherein said tamper resistant switch has a rotational axis substantially parallel to a longitudinal axis of said housing;
c) an electrical component connected to said housing; and
d) at least one electrical contact coupled to said housing, said at least one electrical contact for coupling to an electrical line;
wherein said tamper resistant switch is in electrical communication with said electrical component to selectively electrically connect said electrical component with said at least one electrical contact.

11. The device as in claim 10, wherein said electrical component is in the form of at least one motion sensor which is coupled to said tamper resistant switch in series, such that when said tamper resistant switch is switched to an on position, said at least one motion sensor receives power.

12. The device as in claim 10, wherein said electrical component is in the form of an indicator light coupled in series with said tamper resistant switch, wherein said indicator light indicates a state of said tamper resistant switch by selectively turning on or off.

13. The device as in claim 10, wherein said electrical component is a light sensor disposed in said housing.

14. The device as in claim 10, wherein said tamper resistant switch comprises a single pole locking switch.

15. The device as in claim 10, wherein said tamper resistant switch comprises a double pole locking switch.

16. The device as in claim 10, wherein said tamper resistant switch comprises a three-way locking switch.

17. The device as in claim 10, wherein said tamper resistant switch comprises a four-way locking switch.

18. The device as in claim 10, wherein said tamper resistant switch comprises a single pole double throw center off switch.

19. The device as in claim 10, wherein said tamper resistant switch comprises a double pole double throw center off switch.

20. The device as in claim 10, wherein said electrical component is in the form of a GFCI receptacle unit.
